(19) United States
(12) Patent Application Publication
(10) Pub. No.: US 2018/0233730 A1
(43) Pub. Date: Aug. 16, 2018

(54) MULTI-LAYERED POROUS FILM, SEPARATOR FOR POWER STORAGE DEVICE, AND POWER STORAGE DEVICE

(71) Applicant: UBE INDUSTRIES, LTD., Ube-shi, Yamaguchi (JP)

(72) Inventors: Shusei OHYA, Chiba-shi (JP); Akihiro MATSUBAYASHI, Chiba-shi (JP); Asumi KAMADA, Ichihara-shi (JP)

(21) Appl. No.: 15/750,769

(22) PCT Filed: Aug. 9, 2016
(86) PCT No.: PCT/JP2016/073441

§ 371 Date: Feb. 6, 2018

(30) Foreign Application Priority Data
Aug. 12, 2015 (JP) 2015-159686
Nov. 12, 2015 (JP) 2015-222359
Aug. 8, 2016 (JP) 2016-155871

(51) Int. Cl. H01M 2/16; B32B 5/18; B32B 5/32; H01G 11/52; H01M 2/14; H01M 10/0525

(52) U.S. Cl. CPC H01M 2/1686; B32B 5/18; B32B 5/32; H01G 11/52; H01M 2/166; H01M 2/1653; B32B 2264/102; H01M 10/0525; B32B 2266/025; B32B 2457/10; B32B 2457/16; B32B 2255/102; B32B 2255/26; H01M 2/145

(57) ABSTRACT

A multi-layered porous film which minimizes the incidence of warpage, and having excellent liquid absorbing property performance in regard to absorbing electrolytic solution. The multi-layered porous film includes a porous layer containing a filler which is layered on at least one surface of a polyolefin porous film containing polypropylene as a raw material, the multi-layered porous film having a total lifting amount of 10 mm or less, which is the sum of the lifting amounts of the four sides, when a rectangular multi-layered porous film obtained by cutting a side length in the machine direction at 60 mm and another side length in the direction substantially orthogonal to machine direction at 60 mm was placed in an environment at 23° C. and a dew point of −20° C. or less for 1 hour; and the porous layer containing the filler is placed on the upper surface or the lower surface.

### TECHNICAL FIELD

The present invention relates to a multi-layered porous film, a separator for a power storage device, and a power storage device.

This application is based upon and claims the benefit of priority to Japanese Patent Application No. 2015-159686 filed in Japan on Aug. 12, 2015, Japanese Patent Application No. 2015-222359 filed in Japan on Nov. 12, 2015, and Japanese Patent Application No. 2016-155871 filed in Japan on Aug. 8, 2016, the entire contents of which are incorporated herein by reference. In addition, the entire contents of Japanese Unexamined Patent Application Publication Nos. 7-307146, 4-181651, 3-80923, 7-268118 and 8-138643 are incorporated herein by reference.

### BACKGROUND ART

In recent years, demand for lithium-ion secondary batteries having a large capacity has been increasing. Regarding the lithium-ion secondary batteries having a large capacity, since the capacity is large, when an internal short circuit occurs, the portion where the internal short circuit occurs generates heat, and as a result, the internal short circuit may expand. Therefore, development of a high-performance separator has been desired which is capable of avoiding accidents frequently occurring in such a case. In addition, separators of porous films produced by stretching are currently widely used, however, these are not always satisfactory in film shape maintaining characteristics. Separators having improved film shape maintaining characteristics even at high temperatures are in demand.

Various attempts have been made to solve the problems of the conventional polyolefin porous film. For example, a battery separator in which heat resistance stability is improved by forming a heat resistant porous layer containing heat resistant fine particles as a main component on a polyolefin membrane has been proposed as a separator that achieves both the blocking function of the membrane hole at abnormal heat generation and the film shape maintaining characteristic at high temperature.

In the multilayer separator, the heat resistant porous layer is formed by applying a composition for forming a heat resistant porous layer such as a slurry on one side of the polyolefin membrane. As a general technique for forming the porous layer, a melt extrusion method, a phase separation method, a solvent casting method and the like can be used. When the porous film is formed by these methods, the volume shrinks because the density is increased by precipitation or solidification of the heat-resistant layer. Therefore, in a single-sided coating, warping (curling) occurs severely in the multilayer separator in order to alleviate this shrinkage. Therefore, handling property cannot be sufficiently satisfied when the porous film used as a separator for a battery is laminated with an electrode. Further, by newly forming the heat resistant layer on the polyolefin film, for example, the air permeability of the separator and the wettability with respect to the electrolytic solution change, and as a result, the performance of the battery may be remarkably deteriorated in some cases.

As a prior art method of solving the problem of warpage, for example, Patent Document 1 proposes a multilayer separator made of a multi-layered porous film in which a layer containing a polymer other than polyolefin is laminated on at least one side of a polyolefin porous film. In this multi-layered porous film, it is described that the lifting amount under a temperature of 23° C. and a humidity of 50% environment is suppressed to 15 mm or less. However, suppression of warping (curl) is not satisfactory because the actual battery assembling process is in an environment of a temperature of 23° C. and a dew point of −20° C. or less (a humidity of about 4.5% or less). In addition, from the viewpoint of improving the production efficiency of the battery assembly process and using a highly viscous electrolytic solution, improvement of the electrolyte solution absorbability of the separator is also required.

### Patent Document

[Patent Document 1] Japanese Unexamined Patent Application Publication No. 2015-26609

### SUMMARY OF THE INVENTION

The present invention has been made in view of the above circumstances, and it is an object of the present invention to provide a separator for a power storage device, which can suppress the occurrence of warpage, and to provide a multi-layered porous film, a separator for a power storage device and a power storage device capable of exhibiting good performance.

The inventor of the present invention has made intensive investigations to solve the above problems and found that a coating liquid containing a filler and a medium is applied to at least one side of a polyolefin porous film and dried at a predetermined drying temperature, while applying a tensile force of 0.1 N/mm or more per unit length of the film, thereby completing the present invention.

That is, the present invention has the following features (1) to (20):

(1) A multi-layered porous film comprising a porous layer containing a filler which is layered on at least one surface of a polyolefin porous film containing polypropylene as a raw material,

wherein the multi-layered porous film has a total lifting amount of 10 mm or less, which is the sum of the lifting amounts of the four sides, when a rectangular multi-layered porous film obtained by cutting a side length in the machine direction at 60 mm and another side length in the direction substantially orthogonal to machine direction at 60 mm was placed in an environment at 23° C. and a dew point of −20° C. or less for 1 hour; and the porous layer containing the filler is placed on the upper surface or the lower surface.

(2) The multi-layered porous film according to (1),

wherein the polyolefin porous film is a multi-layered structure including a polypropylene layer, and a polypropylene constituting the polypropylene layer has a weight average molecular weight of 500,000 to 1,000,000.

(3) The multi-layered porous film according to (2),

wherein the polyolefin porous film has a three-layer structure comprising the polypropylene layer as a surface layer and a polyethylene layer as an inner layer.

(4) The multi-layered porous film according to (3),

wherein a heat shrinkage percentage in the machine direction is 1% or less at 110° C. and a heat shrinkage percentage in the direction substantially orthogonal to machine direction is −1.7% to −1.0% at 110° C.

(5) The multi-layered porous film according to (4), wherein the elongation percentage is 1.0% or more when tension is applied.

(6) The multi-layered porous film according to (3), wherein the electrolytic solution absorption area is 1.5 cm² or more.

(7) The multi-layered porous film according to (1), wherein the filler is an inorganic fine particle.

(8) A separator for a power storage device comprising the multi-layered porous film according to any one of (1) to (7).

(9) A power storage device comprising

the separator for a power storage device according to (8),

a positive electrode, and

a negative electrode.

(10) A method for producing a multi-layered porous film comprising a polyolefin porous film prepared by stretching in a machine direction by a dry stretching method and having a porous layer containing a filler laminated on at least one side thereof,

wherein the multi-layered porous film has a total lifting amount of 10 mm or less, which is the sum of the lifting amounts of the four sides, when a rectangular multi-layered porous film obtained by cutting a side length in the machine direction at 60 mm and another side length in the direction substantially orthogonal to machine direction at 60 mm was placed in an environment at 23° C. and a dew point of −20° C. or less for 1 hour; and the porous layer containing the filler is placed on the upper surface or the lower surface.

(11) The method of producing a multi-layered porous film according to (10), comprising a step of

heating the film while applying a tension of 0.04 N/mm or more per unit length of the film in the machine direction to the film, after applying a coating liquid containing the filler and a medium and drying at a predetermined drying temperature.

(12) The method for producing a multi-layered porous film according to (10), wherein the filler is an inorganic fine particle.

(13) The method of producing a multi-layered porous film according to (12), wherein the heating temperature is 40 to 170° C.

(14) The method for producing a multi-layered porous film according to (13), wherein the time for applying a tension after drying is 60 seconds or less.

(15) The method for producing a multi-layered porous film according to (14), wherein the elongation percentage when tension is applied is 1.0% or more.

(16) The multi-layered porous film produced by the method for producing a multi-layered porous film according to any one of (10) to (15),

wherein the multi-layered porous film has a total lifting amount of 10 mm or less, which is the sum of the lifting amounts of the four sides, when a rectangular multi-layered porous film obtained by cutting a side length in the machine direction at 60 mm and another side length in the direction substantially orthogonal to machine direction at 60 mm was placed in an environment at 23° C. and a dew point of −20° C. or less for 1 hour; and the porous layer containing the filler is placed on the upper surface or the lower surface.

(17) A multi-layered porous film comprising a porous layer containing a filler which is layered on at least one surface of a polyolefin porous film produced by a dry process,

wherein the multi-layered porous film has a total lifting amount of 10 mm or less, which is the sum of the lifting amounts of the four sides, when a rectangular multi-layered porous film obtained by cutting a side length in the machine direction at 60 mm and another side length in the direction substantially orthogonal to machine direction at 60 mm was placed in an environment at 23° C. and a dew point of −20° C. or less for 1 hour; and the porous layer containing the filler is placed on the upper surface or the lower surface.

(18) The multi-layered porous film according to (16), wherein the polyolefin porous film is a multi-layered structure comprising a polypropylene layer.

(19) The multi-layered porous film according to (18), wherein the polyolefin porous film has a three-layer structure comprising the polypropylene layer as a surface layer and a polyethylene layer as an inner layer.

(20) The multi-layered porous film according to (16), wherein a polypropylene constituting the polypropylene layer has a weight average molecular weight of 500,000 to 1,000,000.

According to the multi-layered porous film of the present invention, the occurrence of warping can be suppressed and handling property when laminating with an electrode for use as a separator for a power storage device can be improved. In addition, it is possible to increase liquid absorbency of electrolytic solution.

In general, even in an environment at a temperature of 23° C. and a dew point of −20° C. or lower which is brought into an absolutely dry state, the curling of the multi-layered porous film of the present invention is reduced and the handling property is improved. It is easy to assemble a power storage device such as a lithium-ion secondary battery and trouble at the time of assembly can be reduced.

### BRIEF DESCRIPTION OF THE DRAWINGS

FIG. 1 is a graph showing the curling amount (total lifting amount, 23° C. 50%) of the multi-layered porous films produced in Examples 1 to 7 and Comparative Examples 1 to 4 and the load per unit width of the heat stretching process.

FIG. 2 is a graph showing the curling amount (total lifting amount, dew point −40° C.) of the multi-layered porous films prepared in Examples 1 to 7 and Comparative Examples 1 to 4 and the load per unit width of the heat stretching process.

### DETAILED DESCRIPTION OF THE INVENTION

<Polyolefin Porous Film>

As the polyolefin porous film (polyolefin microporous film) of the present invention, which can be applied to separators for the conventional power storage device, those having sufficient mechanical properties and ion permeability can be suitably selected and used.

In addition, when the multi-layered porous film of the present invention is used as a separator for a power storage device, it is difficult to ensure safety when an internal short circuit occurs when the heat blocking temperature of the multi-layered porous film is too high. And when the heat blocking temperature is too low, since there is a possibility of becoming non-porosity in the temperature range, the convenience of the battery is impaired. Therefore, the heat blocking temperature is set to 110 to 180° C. according to the characteristics of the battery and the use environment, but it is preferable that the heat blocking temperature is set to 120 to 140° C. Further, although the separator for a battery of the present invention has a porous layer (heat resistant layer) containing a filler, in order to maintain the non-porosity to a high temperature, it is preferable that the polyolefin porous film alone has a non-porosity maintaining temperature of 170° C. or more.

In order to satisfy such characteristics, the polyolefin porous film constituting the present invention preferably has a melting point of 150° C. or more, and may be a laminated polyolefin porous film. The laminated polyolefin porous film preferably includes a polyolefin porous film layer having a melting point of 150° C. or more and another polyolefin porous film layer having a melting point in the range of 110° C. to 140° C.

As the polyolefin porous film having a melting point of 150° C. or more, polypropylene (PP) can be used. As the other polyolefin porous film layer having a melting point in the range of 110° C. to 140° C., polyethylene (PE) can be used. A porous film laminated in the order of “PP/PE/PP” is preferable. It is preferable that the polyolefin raw material has a weight average molecular weight of 350,000 to 1,000,000. It is preferable that the weight average molecular weight of the polypropylene (PP) is 500,000 to 1,000,000, and the weight average molecular weight of the polyethylene (PE) is 350,000 to 700,000. It is more preferable that the weight average molecular weight of the polypropylene (PP) is from 550,000 to 800,000, and the weight average molecular weight of the polyethylene (PE) is from 350,000 to 550,000. By using the polypropylene raw material having such a weight average molecular weight, it is possible to carry out more suitable molding processing than before in the production of the porous film, which contributes to suppressing the lifting amount as described later. When the weight average molecular weight is too high, the relaxation time of the polymer becomes long, so that the treatment conditions for suppressing the lifting amount become narrow, which is not preferable.

The thickness of the polyolefin porous film depends on the kind of the battery to be used, but it is preferably 3 to 300 μm, more preferably 10 to 100 μm, still more preferably 16 to 50 μm.

Although the polyolefin porous film varies depending on production conditions and composition of the film, it is necessary to have an appropriate air permeability (gas permeation rate; measured as Gurley value). And the Gurley value is preferably 10 to 1000 sec/100 cc, more preferably 10 to 800 sec/100 cc, and even more preferably 30 to 600 sec/100 cc. When the Gurley value is too high, the function when used as a separator for a battery is not sufficient and there is a risk that the non-uniformity of reaction inside the battery will be increased, which is not preferable. On the other hand, if the Gurley value is too low, it is not preferable because Li dendrites are precipitated at the time of charge and discharge of the battery and the risk of causing troubles is increased.

When the multi-layered porous film of the present invention is used as a separator for a power storage device, to the extent that performance as a separator for a power storage device is not impaired, the multi-layered porous film may contain a resin additive such as filler, particle, colorant, plasticizer, lubricant, flame retardant, anti-aging agent, an antioxidant, an antioxidant or the like; an adhesive, and a reinforcing agent made of an inorganic material.

The method for producing the polyolefin porous film to be used in the present invention is not particularly limited, but examples thereof include those described in Japanese Unexamined Patent Application Publication Nos. 7-307146, 4-181651, 3-80923, 7-268118 8-138643 and the like.

For example, Japanese Unexamined Patent Application Publication No. 7-307146 discloses an invention relating to a method for producing a separator for a battery. This separator includes a multi-layered porous film formed by stretching and laminating three or more laminated films in which polypropylene and polyethylene are alternately laminated.

In particular, a method for producing a separator for a battery obtained by the following method is disclosed. A polypropylene film and a polyethylene film are thermocompression-bonded at a temperature of 120 to 140° C. to obtain a laminated film of three or more layers. The laminated film is heat-treated at a temperature range of 110 to 140° C., and the film is stretched 5 to 200% in a state of being kept at a temperature of minus 20° C. to plus 50° C.; and then, the film is stretched 100 to 400% in a state of being kept at a temperature of 70 to 130° C. to become porous; and then the film is heat-treated at a temperature which is 5 to 45° C. higher than the latter stretching temperature. Further, another method for producing a separator for a battery obtained by the following method is also disclosed. A laminated film of three or more layers is bonded by thermocompression at a temperature of 120 to 140° C. so that the polypropylene film and the polyethylene film are alternately laminated. The obtained laminated film is heat-treated in the temperature range of 110 to 140° C., and stretched 10 to 100% while being kept at the temperature of 20° C. to 35° C., and then the film is stretched 100 to 400% while being kept at a temperature of 70 to 130° C. to become porous; it is heat-treated at a temperature 5 to 45° C. higher than the latter stretching temperature. As a result, the obtained multi-layered porous film has the maximum pore diameter of 0.02 to 2 μm, the porosity of 30 to 80%, the interlayer peel strength of 3 to 60 g/15 mm, the nonporous starting temperature of 135 to 140° C., and a non-porosity maintenance upper limit temperature of 180 to 190° C.

For example, when a polyolefin porous film is produced by a dry stretching method, if necessary, a nucleating agent is added to polymer and the polymer is melt, and then a sheet is formed by an extrusion method or the like. After a heat treatment for crystallization is carried out, the crystal interface is peeled off by stretching the polymer, and as a result, holes can be formed. A polyolefin porous film produced by a dry stretching method is preferable. In the porous film produced by the dry stretching method, the raw material polymer is precisely oriented as compared with the porous film produced by a wet method, and as a result, form-holding characteristic of is better than that of the wet type. It is possible to suppress the lifting amount to be described later. The wet method also performs biaxial stretching treatment in the producing process. However, since after the stretching step, component extraction is carried out by immersing the film in a solvent and then a further drying step is included, the orientation of the polymer molecules is disturbed as compared with the dry stretching method.

As a dry stretching method, for example, the following method is preferred. After polypropylene having a weight average molecular weight of 500,000 to 1,000,000 is melt and extruded into a film shape using a molding apparatus, heat treatment is carried out while fixing the take-off direction. Further, as the polyethylene, high density polyethylene having a weight average molecular weight of 350,000 to 500,000 is melt and extruded into a film shape using a molding apparatus. The heat-treated polypropylene film and polyethylene film are laminated in a three-layer structure by arranging polypropylene in surface layers and polyethylene in an inner layer (intermediate layer), and are thermocompression-bonded at a temperature of 120 to 140° C. by a heating roll, and then cooled by a cooling roll. The obtained unstretched laminated film is stretched by 5 to 200% while being kept at a temperature of −20° C. to +50° C. Subsequently, while being kept at a temperature of 70 to 130° C., the film is high-temperature-stretched in the film length direction (machine direction) until the total stretching amount reached 100 to 400%. And then, it is treated at a temperature 0 to 45° C. higher than the latter stretching temperature to obtain a polyolefin porous film having a three-layer laminated structure of “PP/PE/PP”. In addition, a multilayered polyolefin film may be also produced by using a co-extrusion method using a feed block type die or multi manifold type die.

Further, as described later, in order to form a porous layer containing a filler on at least one side of the polyolefin porous film, a coating liquid containing heat resistant fine particles is applied. Wettability to a coating solution can be adjusted by a surface treatment of the polyolefin porous film before applying the coating solution, and the surface treatment may include ultraviolet ray treatment, corona discharge treatment, plasma discharge treatment and the like. From the viewpoint of homogeneous coating, these surface treatments are preferably carried out only on the surface of the polyolefin porous film. If the processing effect reaches the inside of the polyolefin porous film, “strike through” that the coating solution permeates into the inside of the film and passes through to the back side may be liable to occur.

<Porous Layer Containing Filler>

The porous layer (porous layer containing an inorganic substance) containing the filler of the present invention ensures its heat resistance by containing heat resistant fine particles. In the present specification, “heat resistance” means that shape changing such as deformation is not visually observed at least at 150° C. The heat resistance of the heat resistant fine particles is preferably 200° C. or higher, more preferably 300° C. or higher, further preferably 400° C. or higher. Further, the porous layer containing the filler may be a single layer or a multilayer in which a plurality of layers are laminated.

As the heat resistant fine particles, inorganic fine particles having electrical insulation properties are preferable. Specifically, fine inorganic oxide particles such as iron oxide, silica (SiO₂), alumina (Al₂O₃), TiO₂, magnesia, boehmite, BaTiO₂; inorganic nitride fine particles such as aluminum nitride and silicon nitride; poorly soluble ionic crystal fine particles such as calcium fluoride, barium fluoride and barium sulfate; covalent crystal fine particles such as silicon and diamond; clay fine particles such as montmorillonite; can be used. Here, the inorganic oxide fine particles may be fine particles such as substances derived from mineral resources such as boehmite, zeolite, apatite, kaolin, mullite, spinel, olivine and mica, or artificial substances thereof. Inorganic compounds constituting these inorganic fine particles may be elementally substituted or solid solution as required, and the inorganic fine particles may be surface treated. In addition, the inorganic fine particles are formed by coating the surface of a conductive material such as metal, SnO₂, a conductive oxide such as tin-indium oxide (ITO), a carbonaceous material such as carbon black and graphite with material having electrical insulation properties (for example, the above-mentioned inorganic oxide or the like) so as to have electric insulation properties.

For the heat resistant fine particles, organic fine particles can also be used. Specific examples of the organic fine particles include, fine particles of a crosslinked polymer such as a polymer polyimide, melamine resin, phenol resin, aromatic polyamide resin, crosslinked polymethyl methacrylate (crosslinked PMMA), crosslinked polystyrene (crosslinked PS), polydivinylbenzene (PDVB), benzoguanamine-formaldehyde condensation. Further, fine particles of a heat-resistant polymer such as thermoplastic polyimide can be used. The organic resin (polymer) constituting these organic fine particles can be a mixture, a modified product, a derivative, a copolymer (a random copolymer, an alternating copolymer, a block copolymer, a graft copolymer), or a crosslinked product (in the case of the above heat-resistant polymer) of the above-mentioned materials.

As the heat resistant fine particles, the above-mentioned ones may be used singly or two or more of them may be used in combination. As the heat resistant fine particles, inorganic fine particles and organic fine particles can be used as described above, but they may be appropriately used depending on the application. For example, the particle diameter of boehmite is preferably 0.001 μm or more, more preferably 0.1 μm or more, preferably 15 μm or less, and more preferably 3 μm or less, as an average particle diameter. The average particle diameter of the heat resistant fine particles can be defined as the number average particle diameter measured by dispersing it in a medium which does not dissolve the heat resistant fine particles. As the measurement apparatus, for example, a laser scattering particle size distribution meter (for example, “LA-920” manufactured by HORIBA) is used.

The shape of the heat resistant fine particles may be, for example, a shape close to a spherical shape or a plate shape, but in terms of prevention of a short circuit, it is preferably a plate shape. Representative examples of the plate-like heat-resistant fine particles include plate-like alumina and plate-like boehmite.

The porous layer containing the filler contains heat resistant fine particles as a main component. In the present specification, “containing the heat resistant fine particles as a main component” means that the heat resistant fine particles are 70% by volume or more in terms of the total volume of the constituent components of the porous layer containing the filler. The amount of the heat resistant fine particles in the porous layer containing the filler is preferably 80% by volume or more, more preferably 90% by volume or more, in the total volume of constituent components of the heat resistant layer. By setting the content of the heat resistant fine particles in the porous layer containing the filler to a high content as described above, thermal shrinkage of the whole multilayer porous film can be satisfactorily suppressed.

In addition, it is preferable that an organic binder is contained in the porous layer containing the filler in order to bind heat resistant fine particles containing as a main component, and in order to bind the porous layer containing the filler to the polyolefin porous film. From such a viewpoint, a preferable upper limit value of the amount of the heat resistant fine particles in the porous layer containing the filler is, for example, 99 vol % in the total volume of constituent components of the filler-containing porous layer. If the amount of the heat resistant fine particles in the porous layer containing the filler is too small, for example, it is necessary to increase the amount of the organic binder in the porous layer containing the filler, however in that case, the pores of the porous layer containing the filler is buried by the organic binder. For example, there is a possibility that the function as a separator is lost. In addition, when porous is made by using a pore-forming agent or the like, the space between the heat-resistant fine particles becomes too large and the effect of suppressing the thermal shrinkage may decrease.

The organic binder used for the porous layer containing the filler is not particularly limited. There is no particular limitation as long as it can adhere well the porous layer containing the heat resistant fine particles or the filler and the polyolefin porous film. There is no particular limitation as long as it is electrochemically stable. When it is used for a separator for a secondary battery, there is no particular limitation as long as it is stable with respect to the organic electrolytic solution. Specific examples include ethylene-vinyl acetate copolymer (EVA, copolymer having 20 to 35 mol % of a structural unit derived from vinyl acetate), ethylene-acrylic acid copolymer such as ethylene-ethyl acrylate copolymer, fluororesin [polyvinylidene fluoride (PVDF), etc.], fluorine-based rubber, styrene-butadiene rubber (SBR), carboxymethyl cellulose (CMC), hydroxyethyl cellulose (HEC), polyvinyl alcohol (PVA), polyvinyl butyral (PVB), polyvinyl pyrrolidone (PVP), poly N-vinylacetamide, crosslinked acrylic resin, polyurethane, epoxy resin, polyimide and the like. These organic binders may be used alone, or two or more of them may be used in combination.

Among the above-mentioned organic binders, a heat-resistant resin having heat resistance of 150° C. or higher is preferable. In particular, highly flexible materials such as ethylene-vinyl acetate copolymer (EVA), ethylene-acrylic acid copolymer, ethylene-ethyl acrylate copolymer (EEA), fluorocarbon rubber, styrene-butadiene rubber (SBR) and the like are more preferred. A crosslinked acrylic resin having a low glass transition temperature (self-crosslinking type acrylic resin) having a structure in which butyl acrylate as a main component is crosslinked is also preferable.

When these organic binders are used, they are dissolved in a medium (solvent) of a coating liquid (slurry or the like) for forming a porous layer containing a filler, or in the form of an emulsion dispersed in a coating liquid.

The coating liquid for forming the porous layer containing a filler may include heat resistant fine particles and, if necessary, an organic binder and the like. The coating liquid is a slurry obtained by dispersing the heat resistant fine particles, the organic binder or the like in a medium such as water or an organic solvent (the organic binder may be dissolved in the medium).

The organic solvent used as the medium of the coating liquid is not particularly limited as long as it does not damage the porous polyolefin film by dissolving or swelling the polyolefin porous film. In the case of using an organic binder, there is no particular limitation as long as it can uniformly dissolve the organic binder. Furans such as tetrahydrofuran (THF); ketones such as methyl ethyl ketone (MEK) and methyl isobutyl ketone (MIBK); and the like are suitable. An organic solvent having a high boiling point is not preferable, because the polyolefin porous film may be damaged by thermal melting or the like when the organic solvent is removed by drying or the like after applying the composition for forming the porous layer containing the filler to the polyolefin porous film. In addition, a polyhydric alcohol (ethylene glycol, triethylene glycol, etc.) and a surfactant (linear alkylbenzene sulfonate, polyoxyethylene alkyl ether, polyoxyethyl alkyl phenyl ether, etc.) and the like may be added to the organic solvent.

Water may also be used as a medium for the coating solution, and alcohol (alcohol having a carbon number of 6 or less such as ethanol, isopropanol etc.) or a surfactant (for example, which is exemplified as those which can be used for the above-mentioned composition for forming a porous layer, which contains a filler and an organic solvent as medium) may be added.

<Production Method of Multi-Layered Porous Film>

A method of producing a multi-layered porous film of the present invention comprises steps of preparing the polyolefin porous film, coating a coating liquid containing the heat resistant fine particles as a main component on one surface or both surfaces of the polyolefin porous film, and drying the applied coating liquid to form a porous layer containing a filler.

As a method of applying the coating liquid on the polyolefin porous film, a usual casting or coating method using a conventionally known coating apparatus such as a roll coater, an air knife coater, a blade coater, a rod coater, a bar coater, a comma coater, a gravure coater, a silk screen coater, a die coater, a micro gravure coater method and the like can be used.

A porous layer containing a filler is formed by drying a coating liquid applied to one side or both sides of a polyolefin porous film to remove the medium in the coating liquid.

In the multi-layered porous film of the present invention, the thickness of the porous layer containing the filler is not particularly limited, but is preferably 0.5 μm to 50 μm, more preferably 1 μm to 10 μm. If the porous layer containing the filler is too thin, the effect of preventing the meltdown will be insufficient, whereas if it is too thick, there is a high risk that defects such as cracking in the heat resistant layer will occur when the separator is formed into a roll shape or in the process of incorporating the separator into the battery, which is not preferable. In addition, since the amount of introduced electrolyte increases, which contributes to an increase in battery production cost, and the energy density per unit volume and weight of the battery decreases. Therefore, it is not preferable that the porous layer containing the filler is too thick.

The standard deviation of the film thickness of the porous layer containing the filler is preferably 1.4 μm or less, more preferably 1.2 μm or less, further preferably 1.0 μm or less, and even further preferably 0.8 μm or less.

The thickness of the multi-layered porous film of the present invention (the total of the thickness of the polyolefin porous film and the thickness of the porous layer containing the filler) is not particularly limited, but it is preferably 4 to 300 μm, more preferably 9 to 100 μm, and further preferably 16 to 50 μm. If the film thickness is too small, the effect of preventing meltdown is insufficient and the effect of suppressing short circuit due to Li dendrite also becomes insufficient, which is not preferable. If the film thickness is too large, when the film is used as a battery separator, the amount of introduced electrolyte increases, which is a factor of increasing the production cost of the battery, which is not preferable. In addition, the energy density per unit volume and weight of the battery decreases, which is not preferable.

When the average film thickness of the polyolefin porous film is a (μm) and the average film thickness of the filler-containing porous layer (filler layer) is b (μm), the value of the film thickness ratio a/b is preferably 1 to 20, more preferably 2 to 10, and still more preferably 3 to 10. When the film thickness of the porous layer containing the filler is increased with respect to the polyolefin porous film, the holding ratio of the electrolytic solution is deteriorated, and therefore the value of the film thickness ratio a/b is most preferably about 3.3 to 5.

The Gurley value (air permeability) of the multi-layered porous film of the present invention is not particularly limited, but is preferably 10 to 1000 sec/100 cc, more preferably 10 to 800 sec/100 cc, and still more preferably 30 to 600 sec/100 cc. When the Gurley value is too high, the function when used as a multi-layered porous film is not sufficient, and if the Gurley value is too low, there is a risk that the non-uniformity of reaction inside the battery will be increased, which is not preferable.

In the present invention, the standard deviation of the Gurley value of the multi-layered porous film is preferably 12 sec/100 cc or less, and more preferably 10 sec/100 cc or less.

In the multi-layered porous film of the present invention, in order to ensure the function as a multi-layered porous film, the heat blocking temperature is preferably 110° C. to 180° C., and more preferably 110° C. to 140° C.

The method for producing a multi-layered porous film of the present invention preferably further includes a heat stretching step. A heat stretching treatment is performed by steps of cutting out a multi-layered porous film having a porous layer containing a filler into a rectangular shape in width, stretching it until a constant load applied at a constant speed under a predetermination heating condition, and holding the load while heating.

The heat stretching treatment step includes, for example, steps of cutting out a multi-layered porous film having a porous layer containing a filler formed thereon into a rectangular shape in width, stretching it at a speed of 30 to 90 mm/min under a temperature condition of 80 to 120° C. using a tensile tester (for example, a universal testing machine 5582 manufactured by INSTRON Co., Ltd.) while applying a tension of 0.01 N/mm or more, preferably 0.04 N/mm or more per unit length of the film in the machine direction, and holding the load for 0.05 to 5 minutes.

The multi-layered porous film of the present invention is used as a separator for a power storage device of the present invention.

<Nonaqueous Electrolyte>

Preferred examples of the nonaqueous solvent used for the nonaqueous electrolytic solution are a cyclic carbonate and a chain ester. In order to synergistically improve the wide temperature range, especially the electrochemical characteristics at high temperature, it is preferable that a chain ester is contained, more preferable that a chain carbonate is contained, and most preferable that both cyclic carbonate and chain carbonate are contained. The term “chain ester” is used as a concept including a chain carbonate and a chain carboxylate.

As the cyclic carbonate, one or more selected from ethylene carbonate (EC), propylene carbonate (PC) and vinylene carbonate (VC) can be used. A combination of EC and VC, and a combination of PC and VC are particularly preferable.

In addition, when the nonaqueous solvent contains ethylene carbonate and/or propylene carbonate, the stability of the film formed on the electrode increases, and the high temperature and high voltage cycle characteristics are improved. The content of ethylene carbonate and/or propylene carbonate is preferably 3% by volume or more, more preferably 5% by volume or more, further preferably 7% by volume or more with respect to the total volume of the nonaqueous solvent. The upper limit thereof is preferably 45% by volume or less, more preferably 35% by volume or less, still more preferably 25% by volume or less.

As the chain ester, methyl ethyl carbonate (MEC) is used as the asymmetric chain carbonate, dimethyl carbonate (DMC) and diethyl carbonate (DEC) as the symmetric chain carbonate, ethyl acetate (hereinafter referred to as EA) as the chain carboxylic acid ester are preferable. Among the chain esters, a combination of chain esters containing asymmetric and ethoxy groups such as MEC and EA can be used.

The content of the chain ester is not particularly limited, but it is preferably in the range of 60 to 90% by volume with respect to the total volume of the nonaqueous solvent. If the content is 60% by volume or more, the viscosity of the nonaqueous electrolyte does not become excessively high, and when it is 90% by volume or less, it is impossible that the electric conductivity of the nonaqueous electrolyte decreases and the electrochemical characteristics over a wide temperature range, especially at high temperature deteriorates.

Among chain esters, the ratio of the volume occupied by EA is preferably 1% by volume or more, more preferably 2% by volume or more in the nonaqueous solvent. The upper limit thereof is more preferably 10% by volume or less, and still more preferably 7% by volume or less. More preferably, the asymmetric chain carbonate has an ethyl group, and particularly preferably methylethyl carbonate.

The ratio of the cyclic carbonate to the chain ester is preferably from 10:90 to 45:55, more preferably from 15:85 to 40:60, and particularly preferably from 20:80 to 35:65, from the viewpoint of improving the electrochemical characteristics at a wide temperature range, particularly at high temperature.

<Electrolyte Salt>

As the electrolyte salt contained in the nonaqueous electrolytic solution, a lithium salt is preferably used.

As the lithium salt, one or more selected from the group consisting of LiPF₆, LiBF₄, LiN(SO₂F)₂, and LiN(SO₂CF₃)₂ is preferable, and one or more selected from LiPF₆, LiBF₄ and LiN(SO₂F)₂, two or more kinds are more preferable, and LiPF₆ is most preferably used.

<Production of Nonaqueous Electrolyte>

A nonaqueous electrolytic solution is prepared by, for example, a method in which the above-mentioned nonaqueous solvent is mixed and a composition obtained by mixing the above electrolyte salt and a solubilizing agent for the nonaqueous electrolytic solution at a specific mixing ratio is added thereto. In this case, it is preferable that the compound which is added to a nonaqueous solvent and a nonaqueous electrolytic solution to be used is a compound which is purified in advance as much as possible so that impurities are minimized as far as the productivity is not remarkably lowered.

A multi-layered porous film laminated with a porous layer containing the filler of the present invention can be used as the first and second power storage devices below as a separator for a power storage device. As the nonaqueous electrolyte, not only a liquid form but also a gel form can be used. Among them, it is preferable to use it as a separator for a lithium-ion battery (first power storage device) using a lithium salt as an electrolyte salt or as a separator for a lithium-ion capacitor (second power storage device). It is more preferably used for a lithium-ion battery, and more preferably for a lithium-ion secondary battery.

<Lithium-Ion Secondary Battery>

The lithium-ion secondary battery as the power storage device of the present invention includes a positive electrode, a negative electrode, and the above nonaqueous electrolytic solution in which an electrolyte salt is dissolved in a nonaqueous solvent. The constituent members such as a positive electrode and a negative electrode can be used without particular limitation.

For example, as a positive electrode active material for a lithium-ion secondary battery, a composite metal oxide with lithium containing one kind or two or more kinds selected from the group consisting of cobalt, manganese, and nickel is used. These positive electrode active materials can be used singly or in combination of two or more.

As such a lithium composite metal oxide, for example, LiCoO₂, LiCo₁₋ₓMxO₂ (where M is one or two or more elements selected from Sn, Mg, Fe, Ti, Al, Zr, Cr, V, Ga, Zn and Cu), LiMn₂O₄, LiNiO₂, LiCo₁₋ₓNiₓO₂, LiCo_{1/3}Ni_{1/3}Mn_{1/3}O₂, LiNi_{0.5}Mn_{0.3}Co_{0.2}Mn_{0.3}O₂, LiNi_{0.8}Mn_{0.1}Co_{0.1}O₂, LiNi_{0.8}Co_{0.15}Al_{0.05}O₂, Li₂MnO₃, and LiMO₂ (M is a transition metal such as Co, Ni, Mn, Fe or the like), and LiNi_{1/2}Mn_{3/2}O₄.

The conductive agent of the positive electrode is not particularly limited as long as it is an electron conductive material which does not undergo chemical change. For example, one or more carbon blacks selected from natural graphite (flaky graphite etc.), graphite such as artificial graphite, acetylene black and the like can be used.

The positive electrode is prepared by mixing the above-mentioned positive electrode active material with a conductive agent such as acetylene black, carbon black and the like, and as well as a binder such as polytetrafluoroethylene (PTFE), polyvinylidene fluoride (PVDF), a copolymer of styrene and butadiene (SBR), a copolymer (NBR) of acrylonitrile and butadiene, and carboxymethyl cellulose (CMC). A solvent is added thereto, and the mixture is kneaded to prepare a positive electrode mixture. The positive electrode mixture is applied to a current collector such as an aluminum foil, a stainless steel plate or the like. After drying and press molding are carried out, it is subjected to heat treatment under predetermined conditions.

As a negative electrode active material for a lithium-ion secondary battery, the material selected from a lithium metal, a lithium alloy, a carbon material capable of inserting and extracting lithium, tin (simple substance), tin compound, silicon (simple substance), silicon compound can be used. One kind or two or more kinds in combination can be used.

When graphite and silicon or a mixture of graphite and silicon compound are used as the negative electrode active material, and the content of silicon and silicon compounds in the total negative electrode active material is 1 to 45 mass %, such the lithium-ion secondary battery is preferable, because it is possible to increase the capacity while suppressing deterioration of electrochemical characteristics and suppressing increase in electrode thickness.

The negative electrode is prepared by kneading the negative electrode mixture containing a conductive agent, a binder, and a high boiling point solvent, which are similar to the preparation of the positive electrode, and then applying the negative electrode mixture to a current collector such as a copper foil or the like. After drying and press molding are carried out, it is subjected to heat treatment under predetermined conditions.

<Lithium-Ion Secondary Battery>

There is no particular limitation on the structure of the lithium-ion secondary battery as one of the power storage devices of the present invention, and a coin type battery, a cylindrical type battery, a rectangular type battery, a laminate type battery or the like can be used.

For example, a wound type lithium-ion secondary battery has a configuration in which an electrode body is accommodated in a battery case together with a nonaqueous electrolytic solution. The electrode body includes a positive electrode, a negative electrode, and a separator. At least a part of the nonaqueous electrolytic solution is impregnated in the electrode body.

In the wound type lithium-ion secondary battery, the positive electrode includes a long sheet-like positive electrode current collector and a positive electrode mixture layer containing a positive electrode active material and provided on a positive electrode current collector. The negative electrode includes a long sheet negative electrode current collector and a negative electrode mixture layer containing a negative electrode active material and provided on the negative electrode current collector.

Like the positive electrode and the negative electrode, the separator is formed in a long sheet shape. The positive electrode and the negative electrode are wound in a cylindrical shape with a separator interposed therebetween. The shape of the electrode body after winding is not limited to a cylindrical shape. For example, after the positive electrode, the separator and the negative electrode are wound, pressure may be applied from the side to form a flat shape.

The battery case includes a bottomed cylindrical case body and a lid for closing the opening of the case body.

The lid and case body, for example, are made of metal, and are insulated from each other. The lid is electrically connected to the positive electrode current collector, and the case main body is electrically connected to the negative electrode current collector. Note that the lid may serve as the positive electrode terminal and the case main body may also serve as the negative electrode terminal.

The lithium-ion secondary battery can be charged and discharged at −40 to 100° C., preferably at −10 to 80° C. Also, as a countermeasure for increasing the internal pressure of the wound-type lithium-ion secondary battery, a safety valve may be provided on the lid of the battery, and a method of making a notch in a member such as a case body of the battery or a gasket can also be adopted. In addition, as a safety measure against overcharge prevention, a current interruption mechanism for detecting the internal pressure of the battery and interrupting the current can be provided on the lid.

<Production of a Wound-Type Lithium-Ion Secondary Battery>

As an example, a producing procedure of a lithium-ion secondary battery will be described below.

First, a positive electrode, a negative electrode, and the separator of the present invention are prepared. Next, the electrode bodies are assembled by superimposing them and winding them in a cylindrical shape. Next, the electrode body is inserted into the case body, and the nonaqueous electrolytic solution is injected into the case body. As a result, the electrode body is impregnated with the nonaqueous electrolytic solution. After injecting the nonaqueous electrolytic solution into the case main body, a cover is put on the case main body, and the lid and the case main body are hermetically sealed. The shape of the electrode body after winding is not limited to a cylindrical shape. For example, after the positive electrode, the separator and the negative electrode are wound, pressure may be applied from the side to form a flat shape.

The lithium-ion secondary battery can be used as a secondary battery for various applications. For example, it can be suitably used as a power source for a drive source such as a motor for driving a vehicle mounted on a vehicle such as an automobile. The type of the vehicle is not particularly limited, but examples thereof include a hybrid car, a plug-in hybrid car, an electric car, a fuel cell car, and the like. Such a lithium-ion secondary battery may be used alone, or a plurality of batteries may be connected in series and/or in parallel.

<Laminated Battery>

In the above description, the wound type lithium-ion secondary battery is described, but the present invention is not limited to this but the present invention may be applied to a laminate type lithium-ion secondary battery.

For example, a positive electrode or a negative electrode is sandwiched by a pair of the separators of the present invention and wrapped. For example, the positive electrode is used as a packaged electrode, and the separator is formed into a rectangular shape having a size somewhat larger than the electrode. While sandwiching the main body of the electrode with a pair of separators, tabs projecting from the electrode end portions are overlapped so as to protrude from the end of the separator. The side edges of the stacked pair of separators are joined together to form a bag. A laminate type battery can be produced by alternately laminating one electrode and the other electrode packed with a bag with this separator and impregnating with an electrolytic solution.

It is preferable that the four corners of the square-shaped separator are formed in a flat shape. For example, if one of the four corners of the separator is warped (curled), this curl must be returned to a flat shape, which results in poor yield of battery manufacture. Furthermore, when the degree of warping is remarkably large, a laminate type battery is formed in a state where the separator is bent, and there is a danger of an internal short circuit. From the above viewpoint, it is preferable that the separator is planar.

<Lithium-Ion Capacitor>

A lithium-ion capacitor is another power storage device of the present invention. Energy can be stored by using the intercalation of lithium-ions to a carbon material such as graphite or the like having the multi-layered porous film, nonaqueous electrolytic solution, positive electrode, and negative electrode of the present invention as a separator are made of metal. Examples of the positive electrode include those utilizing an electric double layer between an activated carbon electrode and an electrolytic solution, those using a doping/dedoping reaction of a π-conjugated polymer electrode, and the like. The electrolytic solution contains at least a lithium salt such as LiPF₆.

### EXAMPLE

Hereinafter, the present invention will be described in more detail with reference to Examples, but the present invention is not limited to these Examples.

The measurement methods for the polyolefin porous film and multi-layered porous film (separator for power storage device) in the following Examples and Comparative Examples are as follows.

[1] Weight Average Molecular Weight

In the present invention, the weight average molecular weights of polypropylene and polyethylene were determined by standard polystyrene conversion using a V200 type gel permeation chromatograph manufactured by Waters Corporation. Two columns of Shodex AT-G+AT 806 MS were used as a column, and measurement was carried out at 145° C. in ortho-dichlorobenzene adjusted to 0.3 wt/vol %, and a differential refractometer (RI) was used as a detector.

[2] Film Thickness

Film thickness was measured with a contact type thickness meter (made by Peacock).

[3] Gurley Value

Gurley value is measured according to JIS P 8117. As a measuring apparatus, a B type Gurley Densometer (manufactured by Toyo Seiki Co., Ltd.) was used. Tighten the sample piece into a circular hole with a diameter of 28.6 mm and an area of 645 mm². With the inner cylinder weight 567 g, the air in the cylinder is caused to pass from the test circular hole portion to the outside of the cylinder. The time for 100 cc of air to pass through was measured to be the air permeability (Gurley value).

[4] Heat Shrinkage Percentage

A sample piece (5×25 mm) was taken from the inside of 10 mm from both sides so that the long sides would be MD and TD, respectively, from the samples prepared according to the following Examples and Comparative Examples. The obtained sample was heated to 110° C. at a raising temperature rate of 3° C./min while applying a load of 19.6 mN with a thermomechanical analyzer (TMA 8310 made by Rigaku), and the shrinkage rate of the sample at that temperature was measured.

[5] Elongation Percentage

In the following Examples and Comparative Examples, an elongation percentage of a sample was measured using a universal tester 5582 manufactured by INSTRON Co., Ltd when performing stretching treatment.

[6] Method for Measuring Total Lifting Amount of Multi-Layered Porous Film of the Present Invention

From the multi-layered porous film (separator for power storage device) described in the Examples and Comparative Examples, a rectangular film having 60 mm of length in the stretching direction (machine direction) and 60 mm of width in the width direction (direction orthogonal to the machine direction) substantially perpendicular to this stretching direction was cut out. The cut multi-layered porous film was placed on a flat surface, and a lifting amount (the height of the warping rise) from the plane in the direction perpendicular to the machine direction and the machine direction in the case where the porous layer containing the filler was on the upper surface was measured. A lifting amount from the plane in the case where it was on the lower surface was also measured. The sum of the lifting amounts for those two cases was taken as the total lifting amount (curl height). In the present invention, a multi-layered porous film having a size of 60 mm×60 mm was cut out in the machine direction and the width direction, respectively. The cutout size is not decided based on the scope of the invention, but since it is possible that the amount of curl may change if the cutout size is different, the measurements according to the present invention are measured with the same size of 60 mm in the machine direction and the width direction in order to compare the curl amounts of the samples of different Examples and Comparative Examples.

The above measurement was carried out in an environment of a temperature of 23° C. and a humidity of 50% and at a temperature of 23° C. in an environment of a dew point of −20° C. or less, especially a dew point of −40° C.

[7] Method for Evaluating Electrolytic Solution Absorbability of Multi-Layered Porous Film of the Present Invention

Multi-layered porous films described in Examples and Comparative Examples were allowed to stand on a glass substrate and 10 μl of an electrolytic solution (ethyl carbonate (EC)/methylethyl carbonate (MEC)/dimethyl carbonate (DMC)=40/30/30, weight % solution containing 1.2 M LiPF₆) was dropped from the height of 1 cm, and after 1 minute, the size (cm²) of the stain area formed in the multi-layered porous film (separator) was measured as electrolytic solution absorb area to evaluate the electrolytic solution absorbability.

### Example 1

(Production of Polyolefin Porous Film A Having Three Layer Structure of “PP/PE/PP”)

Polypropylene having a number average molecular weight of 70,000, a weight average molecular weight of 590,000 to 710,000, and a melting point of 160 to 163° C. was melt and extruded into a film shape of 7 μm in film thickness using a T die molding apparatus. Thereafter, heat treatment at 135° C. for 60 seconds was performed while fixing the take-up direction. Further, high density polyethylene having a number average molecular weight of 20,000, a weight average molecular weight of 380,000 to 400,000, and a density of 0.964 was melt and extruded into a film shape of 5 μm in film thickness using a T die molding machine as polyethylene.

The polyethylene film was subjected to a heat treatment at 120° C. for 60 seconds while the take-up direction was fixed. Thereafter, it was cooled to room temperature.

The heat-treated polypropylene film and polyethylene film were laminated in a three-layer structure by placing polypropylene in surface layers and polyethylene in the inner layer (intermediate layer). This was subjected to thermocompression bonding with a heating roll at a temperature of 120° C. and a linear pressure of 1.8 kg/cm. Thereafter, it was cooled with a cooling roll at 50° C. The film thickness of the obtained unstretched laminated film was 20 μm.

The unstretched laminated film was stretched at 25° C. at a low temperature of 30° C., then stretched at a high temperature in the film length direction (machine direction) until the total stretching amount reached 180% in a hot air circulation oven heated to 123° C., and then at the state of relaxing 30% at 123° C., heat setting for 70 seconds to obtain a polyolefin porous film A having a three-layer laminated structure of “PP/PE/PP”. The thickness of the polyolefin porous film A prepared by stretching in the machine direction by the dry stretching method was 16 μm.

(Manufacture of Multi-Layered Porous Film (Separator for Power Storage Device))

Boehmite (chemical composition AlOOH, average particle size 2 μm, specific surface area 10.7 m²/g), PVB (polyvinyl butyral) and water and isopropyl alcohol (IPA) as a solvent at a weight ratio of 95:5:90:60 were placed in a pot for a planetary ball mill made of alumina. And the mixture was stirred and mixed for 10 minutes with a planetary ball mill to obtain a coating liquid. A polyolefin porous film A fixed on a glass substrate was coated with the coating liquid with a certain thickness with a coater knife. And then, it was vacuum dried at 50° C. to obtain a multi-layered porous film 1 in which a porous layer containing a filler was formed. The thickness of the obtained multi-layered porous film 1 was 20 μm. The thickness of the filler-containing porous layer (filler layer) was 4 μm.

(Heat Stretching Treatment of Multi-Layered Porous Film 1 on which Porous Layer Containing Filler is Formed)

A multi-layered porous film 1 having a porous layer containing the filler prepared in the above process was cut out into a rectangle shape having a width of 60 mm, with a universal testing machine 5582 manufactured by INSTRON at a temperature condition of 100° C. at a speed of 50 mm/min while a load (2.4 N, 0.04 N/mm (load per unit width)) was applied and held at that load for 1 minute.

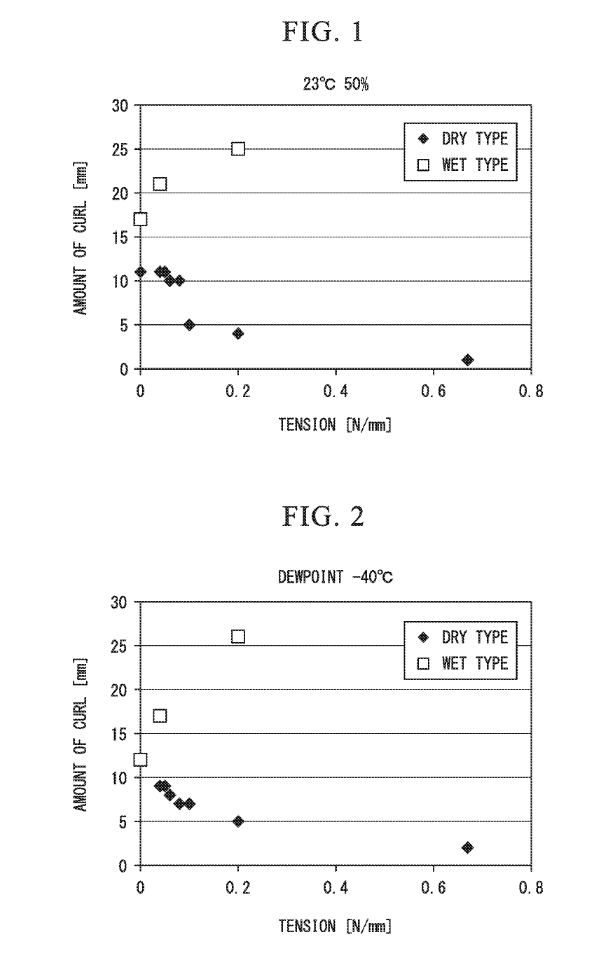

The elongation percentage, Gurley value, curling amount (total lifting amount), electrolytic solution absorbability, and heat shrinkage percentage of the fabricated multi-layered porous film (separator for power storage device) were measured. The results are shown in Table 1, FIG. 1 and FIG. 2.

### Example 2

A multi-layered porous film (separator for a power storage device) was fabricated in the same manner as in Example 1 except that the load of the heat stretching treatment was 3.0 N and the load per unit width was 0.05 N/mm.

The elongation percentage, Gurley value, curling amount (total lifting amount), electrolytic solution absorbability, and heat shrinkage percentage of the fabricated multi-layered porous film (separator for power storage device) were measured. The results are shown in Table 1, FIG. 1 and FIG. 2.

### Example 3

A multi-layered porous film (separator for a power storage device) was prepared in the same manner as in Example 1 except that the load in the heat stretching treatment was 3.6 N and the load per unit width was 0.06 N/mm.

The elongation percentage, Gurley value, curling amount (total lifting amount), electrolytic solution absorbability, and heat shrinkage percentage of the fabricated multi-layered porous film (separator for power storage device) were measured. The results are shown in Table 1, FIG. 1 and FIG. 2.

### Example 4

A multi-layered porous film (separator for a power storage device) was prepared in the same manner as in Example 1 except that the load of the heat stretching treatment was 4.8 N and the load per unit width was 0.08 N/mm.

The elongation percentage, Gurley value, curling amount (total lifting amount), electrolytic solution absorbability, and heat shrinkage percentage of the fabricated multi-layered porous film (separator for power storage device) were measured. The results are shown in Table 1, FIG. 1 and FIG. 2.

### Example 5

A multi-layered porous film (separator for a power storage device) was prepared in the same manner as in Example 1 except that the load in the heat stretching treatment was 6.0 N and the load per unit width was 0.10 N/mm.

The elongation percentage, Gurley value, curling amount (total lifting amount), electrolytic solution absorbability, and heat shrinkage percentage of the fabricated multi-layered porous film (separator for power storage device) were measured. The results are shown in Table 1, FIG. 1 and FIG. 2.

### Example 6

A multi-layered porous film (separator for a power storage device) was prepared in the same manner as in Example 1 except that the load of the heat stretching treatment was 12 N and the load per unit width was 0.20 N/mm.

The elongation percentage, Gurley value, curling amount (total lifting amount), electrolytic solution absorbability, and heat shrinkage percentage of the fabricated multi-layered porous film (separator for power storage device) were measured. The results are shown in Table 1, FIG. 1 and FIG. 2.

### Example 7

A separator for a multi-layered porous film (separator for a power storage device) was prepared in the same manner as in Example 1 except that the load of the heat stretching treatment was 40 N and the load per unit width was 0.67 N/mm.

The elongation percentage, Gurley value, curling amount (total lifting amount), electrolytic solution absorbability, and heat shrinkage percentage of the fabricated multi-layered porous film (separator for power storage device) were measured. The results are shown in Table 1, FIG. 1 and FIG. 2.

### Comparative Example 1

Gurley value, curling amount (total lifting amount), electrolytic solution absorbability, heat shrinkage percentage of a multi-layered porous film (separator for power storage device) having a porous layer containing filler not subjected to heat stretching process prepared by the method of Example 1 were measured. The results are shown in Table 1, FIG. 1 and FIG. 2.

### Comparative Example 2

Polyethylene powder having a weight average molecular weight of 2,000,000 and paraffin wax powder were homogeneously mixed and then mixed at 200° C. using a twin screw type melt kneader. The molten mixture was taken out in a molten state, immediately sandwiched between press plates, heat pressed at 200° C., and then cooled to obtain a sheet having a thickness of about 1 mm Using the simultaneous biaxial stretching machine, the obtained sheet was stretched at a magnification of about 7 times in both longitudinal and transverse directions. Thereafter, the paraffin wax component was extracted by immersing it in n-decane at 60° C. and then n-hexane at room temperature with the four sides fixed with a metal frame. Thereafter, the film was dried to obtain a polyethylene porous film B. The film thickness of the obtained film was 16 μm.

A multi-layered porous film (separator for power storage device) having a porous layer containing filler not subjected to heat stretching process was prepared in the same manner as in Comparative Example 1 except that the polyethylene porous film B obtained by wet method was used. Gurley value, curling amount (total lifting amount), electrolytic solution absorbability, and heat shrinkage percentage were measured. The results are shown in Table 1, FIG. 1 and FIG. 2.

### Comparative Example 3

A multi-layered porous film (separator for a power storage device) was prepared in the same manner as in Example 1 except that the polyethylene porous film B obtained by wet method was used, and the load of the heat stretching treatment was 2.4 N and the load per unit width was 0.04 N/mm.

The elongation percentage, Gurley value, curling amount (total lifting amount), electrolytic solution absorbability, and heat shrinkage percentage of the fabricated multi-layered porous film (separator for power storage device) were measured. The results are shown in Table 1, FIG. 1 and FIG. 2.

### Comparative Example 4

A multi-layered porous film (separator for a power storage device) was prepared in the same manner as in Comparative Example 3 except that the load of the heat stretching treatment was 12 N and the load per unit width was 0.20 N/mm.

The elongation percentage, Gurley value, curling amount (total lifting amount), electrolytic solution absorbability, and heat shrinkage percentage of the fabricated multi-layered porous film (separator for power storage device) were measured. The results are shown in Table 1, FIG. 1 and FIG. 2.

<Reference 1>

The heat shrinkage percentage of the polyolefin porous film A prepared by stretching in the machine direction by the dry stretching method was also measured. The results are shown in Table 1.

<Reference 2>

The heat shrinkage percentage of the polyethylene porous film B obtained by the wet method was also measured. The results are shown in Table 1.

TABLE 1

| | | | | | | Heat | Heat | | | |
|---|---|---|---|---|---|---|---|---|---|---|
| | | Machine | Tension | | | shrinkage | shrinkage | Total lifting amount | | Liquid |
| | | direction | loading | | Gurley | percentage | percentage | | 23° C. Dew | absorption |
| | Original | tension | time | Elongation | value | at 110° C. | at 110° C. | 23° C. | point | area |
| | membrane | N/mm | Sec. | percentage % | Sec./dL | (MD) % | (TD) % | 50% | −40° C. | cm² |
| Example 1 | Dry type | 0.04 | 60 | 0.7 | 270 | 0.6 | −1.0 | 11 | 9 | 1.5 |
| Example 2 | Dry type | 0.05 | 60 | 0.8 | 273 | 0.7 | −1.0 | 11 | 9 | 1.5 |
| Example 3 | Dry type | 0.06 | 60 | 0.8 | 271 | 0.8 | −1.0 | 10 | 8 | 1, 6 |
| Example 4 | Dry type | 0.08 | 60 | 0.9 | 276 | 0.9 | −1.0 | 10 | 7 | 1.7 |
| Example 5 | Dry type | 0.1 | 60 | 1 | 275 | 0.9 | −1.0 | 5 | 7 | 1.7 |
| Example 6 | Dry type | 0.2 | 60 | 2.2 | 270 | 0.8 | −1.5 | 4 | 5 | 2 |
| Example 7 | Dry type | 0.67 | 60 | 9.8 | 218 | 0.5 | −1.7 | 1 | 2 | 2.7 |
| Comparative | Dry type | 0 | 0 | 0 | 278 | 1.2 | −1.0 | 11 | 12 | 1.5 |
| Example 1 | | | | | | | | | | |
| Comparative | Wet type | 0 | 60 | 0 | 330 | — | — | 17 | 12 | — |
| Example 2 | | | | | | | | | | |
| Comparative | Wet type | 0.04 | 60 | 6.3 | 320 | — | −0.8 | 21 | 17 | — |
| Example 3 | | | | | | | | | | |
| Comparative | Wet type | 0.2 | 60 | 20 | 290 | — | −12.5 | 25 | 26 | — |
| Example 4 | | | | | | | | | | |
| Reference 1 | Dry type | — | — | — | 250 | 1.8 | −0.7 | — | — | — |
| Reference 2 | Wet type | — | — | — | 300 | −0.6 | −2.5 | — | — | — |

### INDUSTRIAL APPLICABILITY

According to the present invention, a multi-layered porous film in which the occurrence of warp can be suppressed and the liquid absorbency of the electrolytic solution is high can be provided, and a power storage device can exhibit good performance when the multi-layered porous film is used as a separator for a power storage device. In particular, by using it in a power storage device such as a hybrid electric vehicle, a plug-in hybrid electric vehicle, a lithium-ion secondary battery mounted on a battery electric vehicle, etc., the reliability of these automobiles can be enhanced.

1. A multi-layered porous film comprising a porous layer containing a filler which is layered on at least one surface of a polyolefin porous film containing polypropylene as a raw material,
wherein the multi-layered porous film has a total lifting amount of 10 mm or less, which is the sum of the lifting amounts of the four sides, when a rectangular multi-layered porous film obtained by cutting a side length in the machine direction at 60 mm and another side length in the direction substantially orthogonal to machine direction at 60 mm is placed in an environment at 23° C. and a dew point of −20° C. or less for 1 hour; and the porous layer containing the filler is placed on the upper surface or the lower surface.

2. The multi-layered porous film according to claim 1, wherein the polyolefin porous film is a multi-layered structure including a polypropylene layer, and a polypropylene constituting the polypropylene layer has a weight average molecular weight of 500,000 to 1,000,000.

3. The multi-layered porous film according to claim 2, wherein the polyolefin porous film has a three-layer structure comprising the polypropylene layer as a surface layer and a polyethylene layer as an inner layer.

4. The multi-layered porous film according to claim 3, wherein a heat shrinkage percentage in the machine direction is 1% or less at 110° C. and a heat shrinkage percentage in the direction substantially orthogonal to machine direction is −1.7% to −1.0% at 110° C.

5. The multi-layered porous film according to claim 4, wherein the elongation percentage is 1.0% or more when tension is applied.

6. The multi-layered porous film according to claim 3, wherein the electrolytic solution absorption area is 1.5 cm² or more.

7. The multi-layered porous film according to claim 1, wherein the filler is an inorganic fine particle.

8. A separator for a power storage device comprising the multi-layered porous film according to claim 1.

9. A power storage device comprising:
the separator for a power storage device according to claim 8;
a positive electrode; and
a negative electrode.

10. A method for producing a multi-layered porous film comprising a polyolefin porous film prepared by stretching in a machine direction by a dry stretching method and having a porous layer containing a filler laminated on at least one side thereof,
wherein the multi-layered porous film has a total lifting amount of 10 mm or less, which is the sum of the lifting amounts of the four sides, when a rectangular multi-layered porous film obtained by cutting a side length in the machine direction at 60 mm and another side length in the direction substantially orthogonal to machine direction at 60 mm is placed in an environment at 23° C. and a dew point of −20° C. or less for 1 hour; and the porous layer containing the filler is placed on the upper surface or the lower surface.

11. The method of producing a multi-layered porous film according to claim 10, comprising heating the film while applying a tension of 0.04 N/mm or more per unit length of the film in the machine direction to the film, after applying a coating liquid containing the filler and a medium and drying at a predetermined drying temperature.

12. The method for producing a multi-layered porous film according to claim 10, wherein the filler is an inorganic fine particle.

13. The method of producing a multi-layered porous film according to claim 12, wherein the heating temperature is 40° C. or more and 170° C. or less.

14. The method for producing a multi-layered porous film according to claim 13, wherein the time for applying a tension after drying is 60 seconds or less.

15. The method for producing a multi-layered porous film according to claim 14, wherein the elongation percentage when tension is applied is 1.0% or more.

16. The multi-layered porous film produced by the method for producing a multi-layered porous film according to claim 10, wherein the multi-layered porous film has a total lifting amount of 10 mm or less, which is the sum of the lifting amounts of the four sides, when a rectangular multi-layered porous film obtained by cutting a side length in the machine direction at 60 mm and another side length in the direction substantially orthogonal to machine direction at 60 mm is placed in an environment at 23° C. and a dew point of −20° C. or less for 1 hour; and the porous layer containing the filler is placed on the upper surface or the lower surface.

17. A multi-layered porous film comprising a porous layer containing a filler which is layered on at least one surface of a polyolefin porous film produced by a dry process, wherein the multi-layered porous film has a total lifting amount of 10 mm or less, which is the sum of the lifting amounts of the four sides, when a rectangular multi-layered porous film obtained by cutting a side length in the machine direction at 60 mm and another side length in the direction substantially orthogonal to machine direction at 60 mm is placed in an environment at 23° C. and a dew point of −20° C. or less for 1 hour; and the porous layer containing the filler is placed on the upper surface or the lower surface.

18. The multi-layered porous film according to claim 16, wherein the polyolefin porous film is a multi-layered structure comprising a polypropylene layer.

19. The multi-layered porous film according to claim 18, wherein the polyolefin porous film has a three-layer structure comprising the polypropylene layer as a surface layer and a polyethylene layer as an inner layer.

20. The multi-layered porous film according to claim 16, wherein a polypropylene constituting the polypropylene layer has a weight average molecular weight of 500,000 to 1,000,000.
